(19) United States
(12) Patent Application Publication
(10) Pub. No.: US 2024/0334948 A1
(43) Pub. Date: Oct. 10, 2024

(54) PUFFING METHOD OF NATURAL CHEESE AND A PUFFED PRODUCT USING THE SAME

(71) Applicants: Min-Hang WENG, Kaohsiung City (TW); SUN CARBON TECHNOLOGY Co., Ltd., Kaohsiung City (TW)

(72) Inventors: Min-Hang WENG, Kaohsiung City (TW); Tsung-Chih YU, Kaohsiung City (TW); Tung-Chieh YANG, Kaohsiung City (TW); Chia-Chen CHANG, Kaohsiung City (TW)

(21) Appl. No.: 18/582,129

(22) Filed: Feb. 20, 2024

(30) Foreign Application Priority Data
Apr. 6, 2023 (TW) 112113194

(51) Int. Cl. A23C 19/09; A23C 3/07

(52) U.S. Cl. CPC A23C 19/0912; A23C 3/07; A23C 2250/10

(57) ABSTRACT

A method for puffing natural cheese includes the following steps of: step 1: subjecting a natural cheese to a physical pretreatment to form a target shape; step 2: placing the natural cheese after physical pretreatment into a bearing plate; step 3: sending the natural cheese placed in the bearing plate into a puffing cavity of a puffing equipment; step 4: setting multiple puffing process parameters for the puffing equipment; step 5: providing an electromagnetic energy by the puffing equipment to perform a puffing process on the natural cheese; and step 6: producing a puffed product after the puffing process is completed. A puffed product of natural cheese uses the process disclosed above. The technology of the method and the puffed product has great market potential for the puffed food production of natural cheese.

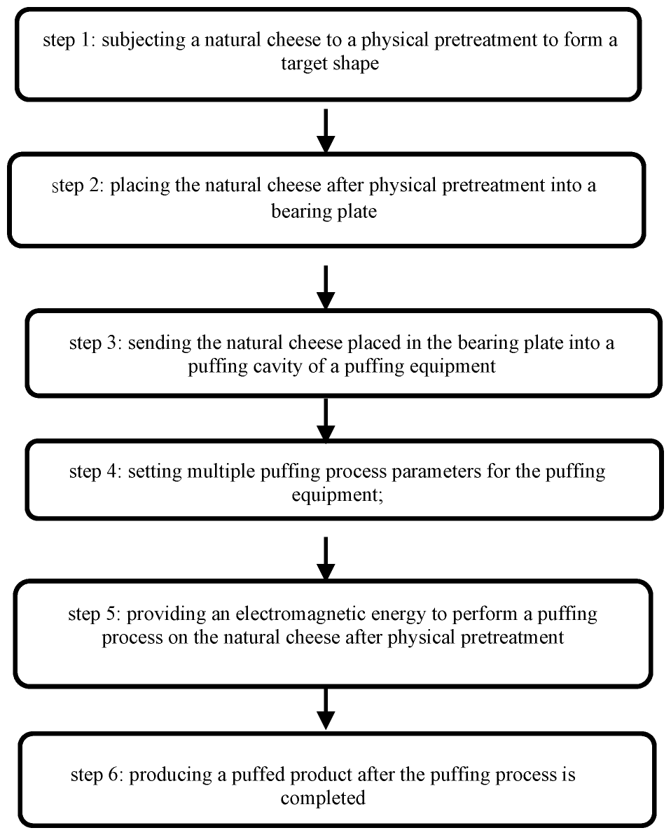

### TECHNICAL FIELD

The present invention relates to a puffing method of cheese and its puffed product of cheese, and more particularly to a puffing method and its puffed products using natural cheese with a lower melting point that cannot be made using traditional puffing equipment as raw materials.

### BACKGROUND

Puffed cheese is a kind of cheese that uses cheese as raw material. Through the Puffing process, the water inside the cheese evaporates and bubbles are generated, so that the pressure difference between the inside and outside of the cheese causes the volume to increase. This phenomenon is called puffing effect. This food product is very popular in the market, but the puffed cheese currently sold on the market uses processed cheese for puffing processing. This is mainly because the processed cheese is used to prevent the cheese from melting due to excessive temperature, so it will add additives such as corn flour, starch, lactic acid bacteria and lecithin to mix to change the molecular structure and increase the melting point of the cheese.

Natural cheese is one of the foods suitable for the ketogenic diet because it is low in carbohydrates, high in protein, high in fat, and rich in nutrients such as calcium, phosphorus, vitamin B12, etc. This makes it one of the important foods for fitness groups who pursue a healthy, strong and attractive FIGURE. Therefore, among the ketogenic diet and fitness groups, it can be predicted that natural cheese puffed food is a food product with great interest and expectation. Natural cheese is well known in the food industry. The main ingredients of natural cheese are animal milk, lactic acid bacteria, salt and rennet (rennet). The melting temperature is between about 35° C. and 70° C. For example, Soft white cheese˜35° C.-40° C., Whey cheese˜70° C.-90° C., Mozzarella cheese˜80° C.-90° C., Feta cheese˜54° C.-57° C. Gouda cheese˜55° C.-60° C., Cheddar cheese˜66° C.-70° C.

After the raw material enters the puffing equipment, it is preheated to a certain temperature. At this time, the moisture in the raw material is heated and quickly boiled, forming a large number of bubbles. The bubbles are quickly released along with the moisture. The volume of the raw material expands instantly due to the pressure difference between the inside and outside, forming puffed structure. However, it should be noted that manufacturing natural cheese puffed food may face some technical difficulties, mainly because the ingredient ratio and physical structure of natural cheese are not suitable for traditional puffing technology and equipment, and the process needs to be improved and adjusted to achieve ideal taste and puffing effect. Some food puffing equipment in the market cannot puff natural cheese. Such as hot air equipment, extrusion equipment or vacuum frying equipment, as explained below.

Hot air equipment is a device that heats and puffs food through hot air. It is usually used to make puffed foods such as popcorn and puffed cereals. In hot air equipment, food is heated by high-speed rotating hot air, which evaporates the water inside the food and generates high pressure, which ultimately causes the food to puff. However, the process temperature is 70-130° C., making it impossible to produce puffed products of natural cheese.

Extrusion equipment is a device that forms a puffing effect by pressing food ingredients through small holes. It is usually used to make puffed foods such as puffed cereals and fermented bean curd. In the extrusion equipment, when the food material passes through the small hole under high pressure, the water inside the food material evaporates due to the sudden pressure change, eventually producing a puffing effect. However, the process temperature is 100-180° C., and it is impossible to produce a puffed product of natural cheese.

Vacuum frying equipment is a device that immerses food in oil and heats it in a vacuum environment to puff it. It is usually used to make puffed food such as puffed potato chips and puffed chicken cakes. In vacuum frying equipment, since oil in a low-pressure environment has a lower boiling point than oil under normal pressure, this causes the water in the food to evaporate faster, ultimately producing a puffing effect. However, the process temperature is 100-200° C. Therefore, puffed product of natural cheese cannot be produced.

Before the natural cheese melts, the water in the cheese needs to be boiled and evaporated to cause its volume to expand instantly, which can effectively achieve the puffing effect. In addition, nutrients such as proteins will be denatured at high temperatures exceeding 70° C., thereby reducing their biological activity; vitamin B12 is sensitive to high temperatures and will begin to decompose at about 50° C.; vitamin C is highly heat sensitive and is about Loss at 60-70° C. . . . Therefore, the temperature of the process needs to be controlled at a temperature where the cheese is puffed and the nutrients are retained after puffing.

The above-mentioned traditional technologies all use heat conduction methods to produce puffed products. Not only are they unable to produce puffed natural cheese, the nutrients in the original natural cheese, such as protein, vitamins, etc., may also be destroyed or lost due to the high-temperature process. In addition, if applied to other products, because the food surface is susceptible to heat, heat transfer technology may cause the food surface to be over-scorched, thus affecting the taste and appearance of the food.

In view of this, it is needed to propose a puffing method of natural cheese and the puffed product of natural cheese, solving the key parameters of natural cheese due to factors such as temperature, time and pressure in the production process to ensure the puffing molding and quality safety of the product.

### SUMMARY

The main purpose of the present invention is to propose a puffing method for natural cheese, which can boil and evaporate the moisture in the cheese before the natural cheese melts, so that its volume instantly expands, which can effectively to achieve the puffing effect, the process temperature needs to be controlled at a temperature where the cheese puffs and the nutrients are retained after puffing. Another object of the present invention is to provide a puffed product of natural cheese that can reduce the volume of the puffed product to 100% to 1000% of the original value at low temperature, while retaining the nutritional content of the raw material.

In order to achieve the main goal of the invention, the invention proposes a method for puffing natural cheese, which includes the following steps of:
step 1: subjecting a natural cheese to a physical pretreatment to form a target shape;
step 2: placing the natural cheese after physical pretreatment into a bearing plate, the material of the bearing plate is selected from an electromagnetic wave absorbing material, a reflecting electromagnetic wave material or an electromagnetic wave penetrating material;
step 3: sending the natural cheese placed in the bearing plate into a puffing cavity of a puffing equipment;
step 4: setting multiple puffing process parameters for the puffing equipment;
step 5: providing an electromagnetic energy by the puffing equipment under the settings of the puffing process parameters to perform a puffing process on the natural cheese after physical pretreatment; and
step 6: producing a puffed product after the puffing process is completed;
wherein, the puffing process parameters at least include a parameter of puffing temperature, a parameter of electromagnetic power density, and a parameter of puffing cavity pressure.

According to one feature of the invention, the natural cheese is non-processed cheese, and the main ingredients of the natural cheese are animal milk, lactic acid bacteria, salt and rennet (rennet) after being matured made cheese.

According to one feature of the invention, the physical pretreatment is selected from one of cutting, extrusion, screening, classification, and reshaping.

According to one feature of the invention, the puffing cavity is a closed vacuum space composed of a material with a resistivity of less than 10⁻⁶ Ωm.

According to one feature of the invention, the parameter of puffing cavity pressure is between 30° C. and 90° C.

According to one feature of the invention, the parameter of electromagnetic power density is between 0.2 kW and 4 kW/kg.

According to one feature of the invention, the parameter of puffing cavity pressure is between an absolute value of 875 Torr and 2 Torr.

A method for puffing natural cheese as described in claim 1, wherein the puffing process parameters including a parameter of puffing temperature, a parameter of electromagnetic power density, and a parameter of puffing cavity pressure are combined into a certain energy mode, a certain temperature mode, a certain time mode, an intermittent energy supply mode or a continuous temperature supply mode.

In order to achieve the another goal of the invention, the invention proposes a puffed product of natural cheese, wherein a volume of the puffed product of natural cheese is 50%-1000% compared to a volume of the natural cheese before puffing, and the puffing temperature of the natural cheese is between 30° C. and 90° C.

According to one feature of the invention, the puffed product of natural cheese is produced by claim 1.

In summary, the kind of puffing method of natural cheese of the present invention and its puffed product have the following effects:
1. Appearance: This technology can produce a more uniform appearance, making the shape of puffed food more perfect.
2. Yield: Compared with traditional heat transfer expansion technology, this puffing technology can more effectively utilize raw materials, reduce the waste of raw materials, and improve product yield.
3. Retention of nutrients: Through electromagnetic energy and pressure control technology, natural cheese can be puffed at a lower temperature, which can reduce the loss of nutrients, retain the natural flavor and nutrients of the raw materials, and improve the quality of the product. quality.
4. Production efficiency: Through electromagnetic energy and pressure control technology, it can be completed in a shorter time, which can improve production efficiency and reduce production costs. More importantly, it will not cause the melting of natural cheese, which is the current traditional puffing equipment. There is no way to achieve the effect.

Based on the above advantages, the technology of the present invention has great market potential for the production of puffed food of natural cheese.

### BRIEF DESCRIPTION OF THE DRAWINGS

In order to make the above-mentioned and other purposes, features, and advantages of the present invention more obvious and understandable, several preferred embodiments are specifically described below, and in conjunction with the accompanying drawings, the detailed description is as follows.

The FIGURE shows a flow chart of a natural cheese puffing method according to the present invention.

### BRIEF DESCRIPTION OF THE DRAWINGS

The present inventions now will be described more fully hereinafter with reference to the accompanying drawings, in which some, but not all embodiments of the inventions are shown. Indeed, these inventions may be embodied in many different forms and may not be construed as limited to the embodiments set forth herein; rather, these embodiments are provided, so that this disclosure will satisfy applicable legal requirements.

In order to achieve the main goal of the invention, the invention proposes a puffing method of natural cheese and a puffed product using the same.

Please refer to the FIGURE, which is a flow chart of a natural cheese puffing method according to the present invention. The method for puffing natural cheese, which includes the following steps of:
step 1: subjecting a natural cheese to a physical pretreatment to form a target shape;
step 2: placing the natural cheese after physical pretreatment into a bearing plate, the material of the bearing plate is selected from an electromagnetic wave absorbing material, a reflecting electromagnetic wave material or an electromagnetic wave penetrating material;
step 3: sending the natural cheese placed in the bearing plate into a puffing cavity of a puffing equipment;
step 4: setting multiple puffing process parameters for the puffing equipment;
step 5: providing an electromagnetic energy by the puffing equipment under the settings of the puffing process parameters to perform a puffing process on the natural cheese after physical pretreatment; and
step 6: producing a puffed product after the puffing process is completed;
wherein, the puffing process parameters at least include a parameter of puffing temperature, a parameter of electromagnetic power density, and a parameter of puffing cavity pressure.

In step 1, the natural cheese is subjected to the physical pretreatment to obtain the target shape. The main ingredients of the natural cheese are animal milk, lactic acid bacteria, salt and cheese made after aging with rennet (rennet). The natural cheese may include Parmigiano-Reggiano, Cheddar, Gouda, Roquefort, Manchego, Feta, Brie, Camembert, Monterey Jack, Tillamook Cheddar, Emmental: Emmental, Gruyère, Roquefort, Parmigiano-Reggiano . . . etc. In addition to the above ingredients, this natural cheese does not have additional additives such as corn flour, starch, lactic acid bacteria and lecithin for mixing the cheese and additional drying before processing.

The target shape can be processed by the physical pretreatment on the natural cheese according to the manufacturing process, product or preference requirements. This physical pretreatment refers to the use of manual or mechanical methods, such as physical cutting, extrusion, screening, classification, reshaping, etc., to form the shape before the pre-puffing process. In an embodiment of the present invention, the physical pretreatment is performed by cutting the natural cheese into diced shapes of about 0.2 cm³-2 cm³, and then placing the natural cheese in the target shape into the bearing plate.

In step 2, the natural cheese with physical pretreatment is placed in the bearing plate. The material of the bearing plate is selected from an electromagnetic wave absorbing material, a reflecting electromagnetic wave material or an electromagnetic wave penetrating material. The electromagnetic wave-absorbing material can be silicon carbide or carbon steel materials; the electromagnetic wave-reflecting material can be Matta loose iron series or Wosfield iron series stainless steel, copper, aluminum, gold . . . and other metals; the electromagnetic wave penetrating material can be food-use level material made of high-grade polypropylene (PP), polycarbonate (PC), polyethylene (PE), and Teflon (Teflon) materials. In the embodiment of the present invention, the bearing plate made of Teflon is used. After the physical pretreatment, the natural cheese having the target shape is placed on the bearing plate and sent to the puffing cavity in the puffing equipment.

In step 3, the natural cheese placed in the bearing plate is sent into the puffing cavity of the puffing equipment. The puffing cavity is a closed vacuum space composed of a material with a resistivity less than 10⁻⁶ Ω-m. Specifically, the material of puffing cavity can be a space made, composed, synthesized, and assembled of metals such as Wochfield iron series, Matta loose iron series, fertilized iron series, stainless steel, copper, aluminum, gold, etc. In the embodiment of the present invention, the puffing cavity is made of Wochonite stainless steel. After the bearing plate is sent into the puffing cavity of the puffing equipment, the parameters of puffing process including a parameter of puffing temperature, a parameter of electromagnetic power density, and a parameter of puffing cavity pressure can be set.

In step 4: setting multiple puffing process parameters for the puffing equipment, wherein the puffing process parameters including a parameter of puffing temperature, a parameter of electromagnetic power density, and a parameter of puffing cavity pressure are combined into a certain energy mode, a certain temperature mode, a certain time mode, an intermittent energy supply mode or a continuous temperature supply mode . . . and other modes of the puffing equipment.

Wherein, the electromagnetic energy is selected from the electromagnetic energy of non-ionizing radiation such as radio, microwave, infrared, visible light. The electromagnetic energy is often expressed as power density; the puffing temperature is expressed as the temperature value during the puffing process of the natural cheese after the physical pretreatment; the puffing time is the time for the electromagnetic energy to output energy in the puffing process; the puffing cavity pressure is the pressure inside the puffing cavity during the puffing process; the humidity value is the humidity inside the puffing cavity during the puffing process; the pumping rate is the pumping rate for the gas generated inside the puffing cavity due to the puffing process. Note that, specific parameters can be selected and set according to the puffing process requirements. Not all parameters need to be set, but at least the parameter of puffing temperature, the parameter of electromagnetic power density, and the parameter of puffing cavity pressure, are required.

The parameter of puffing temperature is between 20° C. and 120° C. Preferably, the parameter of puffing temperature r is between 30° C. and 60° C. The parameter of electromagnetic power density is between 0.1 kW/kg and 6 kW/kg. Preferably, the parameter of electromagnetic power density is between 0.2 kW/kg and 4 kW/kg. The parameter of puffing cavity pressure is between an absolute value of 875 Torr and 2 Torr. Preferably, the parameter of puffing cavity pressure is between an absolute value of 875 Torr and 0.1 Torr.

In step 5, the puffing equipment provides an electromagnetic energy under the parameter of puffing process set to perform the puffing process on the natural cheese with physical pretreatment. The puffing equipment provides the electromagnetic energy, it also maintains the natural cheese after the physical pretreatment at the set puffing temperature, puffing pressure and other puffing parameters in the puffing cavity. The puffing parameters and modes provided by the puffing equipment are based on the set values. Available in different combinations according to the process needs, there are different choices for different cheese ingredients.

In an embodiment of the present invention, the electromagnetic energy is microwave energy, combined with other parameters such as the temperature, the pressure, etc., to perform a puffing process on the natural cheese. There are two special features: One is that electromagnetic energy has high dielectric selective heating characteristics, so it is particularly sensitive to the heating of moisture. Compared with other ingredients in the natural cheese, electromagnetic energy is different from traditional surface heat transfer technology, and it can directly heat the area with higher moisture content inside the natural cheese, helping to produce the puffing effect of the natural cheese with physical pretreatment. Another, if the pressure is set lower than the atmospheric pressure, it will help to make the natural cheese be boiled at a lower temperature, forming more bubbles inside, thereby producing a greater puffing effect. This is the important characteristic of the present invention which is a puffing technology that cannot be achieved by using traditional heat transfer mechanisms such as hot air equipment, extrusion puffing equipment, and vacuum frying equipment.

In step 6, the puffed product is produced after the puffing process is completed. Note that, puffing process parameters such as temperature and pressure during the puffing process need to be accurately controlled to ensure that the final puffed effect meets the required nutritional content, since protein will be denatured at high temperatures exceeding 70° C., thereby reducing its biological activity; vitamin B12 is sensitive to high temperatures and will begin to decompose at about 50° C.; vitamin C is highly heat sensitive, about 60-70° C.

In the embodiment of the present invention, the time mode is adopted, the parameter of puffing temperature is set to 50° C., the parameter of puffing cavity pressure is set to 500 Torr, the electromagnetic energy is microwave with a frequency of 2.45 GHz, and parameter of electromagnetic power density is 0.6 Kw/kg and parameter of puffing time is 60 minutes, the puffed product can be produced with a volume that is approximately 200% greater than that of natural cheese before puffing.

In another embodiment of the present invention, the intermittent energy supply mode is adopted, which is divided into two stages to set the electromagnetic energy. In the first stage, the parameter of puffing cavity pressure, the parameter of electromagnetic power density and parameter of puffing time are 675 Torr, 1.5 kW/kg, 10 minutes, respectively; In the first stage, the parameter of puffing cavity pressure, the parameter of electromagnetic power density and parameter of puffing time are 150 Torr, 0.5 kW/kg, 50 minutes, respectively. In this embodiment, the puffed product can be produced with a volume that is approximately 700% greater than that of natural cheese before puffing.

In summary, the kind of puffing method of natural cheese of the present invention and its puffed product have the following effects:
1. Appearance: This technology can produce a more uniform appearance, making the shape of puffed food more perfect.
2. Yield: Compared with traditional heat transfer expansion technology, this puffing technology can more effectively utilize raw materials, reduce the waste of raw materials, and improve product yield.
3. Retention of nutrients: Through electromagnetic energy and pressure control technology, natural cheese can be puffed at a lower temperature, which can reduce the loss of nutrients, retain the natural flavor and nutrients of the raw materials, and improve the quality of the product. quality.
4. Production efficiency: Through electromagnetic energy and pressure control technology, it can be completed in a shorter time, which can improve production efficiency and reduce production costs. More importantly, it will not cause the melting of natural cheese, which is the current traditional puffing equipment. There is no way to achieve the effect.

Many modifications and other embodiments of the present disclosure set forth herein will come to mind to one skilled in the art to which the present disclosed subject matter pertains having the benefit of the teachings presented in the foregoing descriptions and the associated drawings. Therefore, it is to be understood that the present subject matter is not to be limited to the specific embodiments disclosed and that modifications and other embodiments are intended to be included within the scope of the appended claims. Although specific terms are employed herein, they are used in a generic and descriptive sense only and not for purposes of limitation. It will be understood that various details of the presently disclosed subject matter may be changed without departing from the scope of the presently disclosed subject matter. Furthermore, the foregoing description is for the purpose of illustration only, and not for the purpose of limitation.

1. A method for puffing natural cheese, which includes the following steps of:
step 1: subjecting a natural cheese to a physical pretreatment to form a target shape;
step 2: placing the natural cheese after physical pretreatment into a bearing plate, the material of the bearing plate is selected from an electromagnetic wave absorbing material, a reflecting electromagnetic wave material or an electromagnetic wave penetrating material;
step 3: sending the natural cheese placed in the bearing plate into a puffing cavity of a puffing equipment;
step 4: setting multiple puffing process parameters for the puffing equipment;
step 5: providing an electromagnetic energy by the puffing equipment under the settings of the puffing process parameters to perform a puffing process on the natural cheese after physical pretreatment; and
step 6: producing a puffed product after the puffing process is completed;
wherein, the puffing process parameters at least include a parameter of puffing temperature, a parameter of electromagnetic power density, and a parameter of puffing cavity pressure.

2. The method for puffing natural cheese as described in claim 1, wherein the natural cheese is non-processed cheese, and the main ingredients of the natural cheese are animal milk, lactic acid bacteria, salt and rennet (rennet) after being matured made cheese.

3. The method for puffing natural cheese as described in claim 1, wherein the physical pretreatment is selected from one of cutting, extrusion, screening, classification, and reshaping.

4. The method for puffing natural cheese as described in claim 1, wherein the puffing cavity is a closed vacuum space composed of a material with a resistivity of less than 10-6 Ωm.

5. The method for puffing natural cheese as described in claim 1, wherein the parameter of puffing cavity pressure is between 30° C. and 90° C.

6. The method for puffing natural cheese as described in claim 1, wherein the parameter of electromagnetic power density is between 0.2 kW and 4 kW/kg.

7. The method for puffing natural cheese as described in claim 1, wherein the parameter of puffing cavity pressure is between an absolute value of 875 Torr and 2 Torr.

8. The method for puffing natural cheese as described in claim 1, wherein the puffing process parameters including a parameter of puffing temperature, a parameter of electromagnetic power density, and a parameter of puffing cavity pressure are combined into a certain energy mode, a certain temperature mode, a certain time mode, an intermittent energy supply mode or a continuous temperature supply mode.

9. A puffed product of natural cheese, wherein a volume of the puffed product of natural cheese is 50%-1000% compared to a volume of the natural cheese before puffing, and the puffing temperature of the natural cheese is between 30° C. and 90° C.

10. The puffed product of natural cheese as described in claim 9, wherein the puffed product of natural cheese is produced by a method for puffing natural cheese, which includes the following steps of:
step 1: subjecting a natural cheese to a physical pretreatment to form a target shape;
step 2: placing the natural cheese after physical pretreatment into a bearing plate, the material of the bearing plate is selected from an electromagnetic wave absorbing material, a reflecting electromagnetic wave material or an electromagnetic wave penetrating material;
step 3: sending the natural cheese placed in the bearing plate into a puffing cavity of a puffing equipment;
step 4: setting multiple puffing process parameters for the puffing equipment;
step 5: providing an electromagnetic energy by the puffing equipment under the settings of the puffing process parameters to perform a puffing process on the natural cheese after physical pretreatment; and
step 6: producing a puffed product after the puffing process is completed;
wherein, the puffing process parameters at least include a parameter of puffing temperature, a parameter of electromagnetic power density, and a parameter of puffing cavity pressure.
